(19) United States
(12) Patent Application Publication
(10) Pub. No.: US 2026/0285172 A1
(43) Pub. Date: Sep. 24, 2026

(54) FUEL CELL VEHICLE AND METHOD OF MANUFACTURING FUEL CELL VEHICLE

(71) Applicant: HONDA MOTOR CO., LTD., TOKYO (JP)

(72) Inventor: Takuya KANDA, WAKO-SHI (JP)

(21) Appl. No.: 19/573,015

(22) Filed: Mar. 20, 2026

(30) Foreign Application Priority Data
Mar. 24, 2025 (JP) 2025-048483

(51) Int. Cl. B60L 50/71; B60K 1/04

(52) U.S. Cl. CPC B60L 50/71; B60K 1/04; B60K 2001/0405

(57) ABSTRACT

A fixing structure of a fuel cell vehicle includes a pivot member supported in a pivotable manner on a subframe and displaceable between a retracted position and a fixed position. At the retracted position of the pivot member, the width of the fixing structure is smaller than the inter-frame distance of a pair of side frames. At the fixing position of the pivot member, the width of the fixing structure is larger than the inter-frame distance, and the fixing structure with the pivot member at the fixing position is fixed to the vehicle body frame.

### CROSS-REFERENCE TO RELATED APPLICATIONS

This application is based upon and claims the benefit of priority from Japanese Patent Application No. 2025-048483 filed on Mar. 24, 2025, the contents of which are incorporated herein by reference.

### BACKGROUND OF THE INVENTION

### Field of the Invention

The present disclosure relates to a fuel cell vehicle and a method for manufacturing a fuel cell vehicle.

### Description of Related Art

JP 2005-231549 A discloses a fuel cell vehicle in which a fuel cell system is mounted. A fuel cell vehicle is provided with a fuel cell module and a mounting member, which is mounted to a side of the fuel cell module. The fuel cell module is fixed to a side frame of a vehicle body frame via the mounting member.

### SUMMARY OF THE INVENTION

In the fuel cell vehicle described above, it is desired to improve the ease of assembly of the fuel cell module with respect to the side frame.

The present disclosure aims to solve the aforementioned problems.

A fuel cell vehicle of the present disclosure includes a vehicle body frame including a pair of side frames facing each other in the vehicle width direction, a fuel cell module, and a fixing structure configured to fix the fuel cell module to the pair of side frames, wherein each of the pair of side frames includes a frame fastening portion to which the fixing structure is fastened, and a projecting portion projecting inward in the vehicle width direction from the frame fastening portion, the fixing structure includes a subframe to which the fuel cell module is fixed, and a pivot member supported in a pivotable manner on the subframe and displaceable between a retracted position and a fixed position projecting outward in the vehicle width direction with respect to the subframe, at the retracted position of the pivot member, the width of the fixing structure in the vehicle width direction is smaller than the inter-frame distance that is the width between the projecting portions of the pair of side frames in the vehicle width direction, and at the fixed position of the pivot member, the width of the fixing structure in the vehicle width direction is larger than the inter-frame distance, and the fixing structure with the pivot member at the fixed position is fixed to the vehicle body frame.

According to the present disclosure, the ease of assembly of the fuel cell module with respect to a pair of side frames can be improved.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic plan view of a fuel cell vehicle according to an embodiment of the present disclosure;

FIG. 2 is an enlarged plan view showing a fixing structure in the fuel cell vehicle of FIG. 1;

FIG. 3 is a cross-sectional view taken along line III-III of FIG. 2;

FIG. 4 is a side view of the fuel cell vehicle shown in FIG. 1; and

FIG. 5 is an explanatory diagram showing a method for manufacturing a fuel cell vehicle.

### DETAILED DESCRIPTION OF THE INVENTION

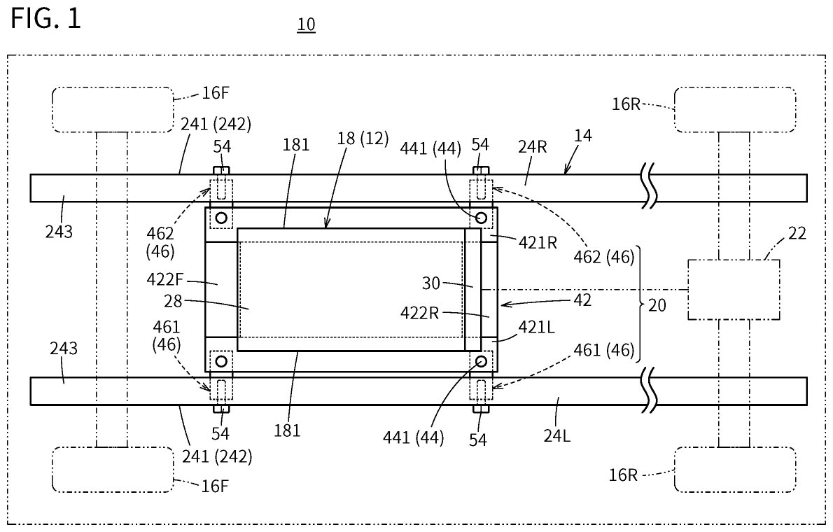

As shown in FIG. 1, a fuel cell vehicle 10 according to the present embodiment is equipped with a fuel cell system 12. The fuel cell vehicle 10 includes a vehicle body frame 14, front wheels 16F, rear wheels 16R, a cell module 18, a fixing structure 20, and a motor 22. The motor 22 is operated by power supplied from the fuel cell module 18 and drives at least the front wheels 16F or the rear wheels 16R. The motor 22 is fixed to, for example, the vehicle body frame 14.

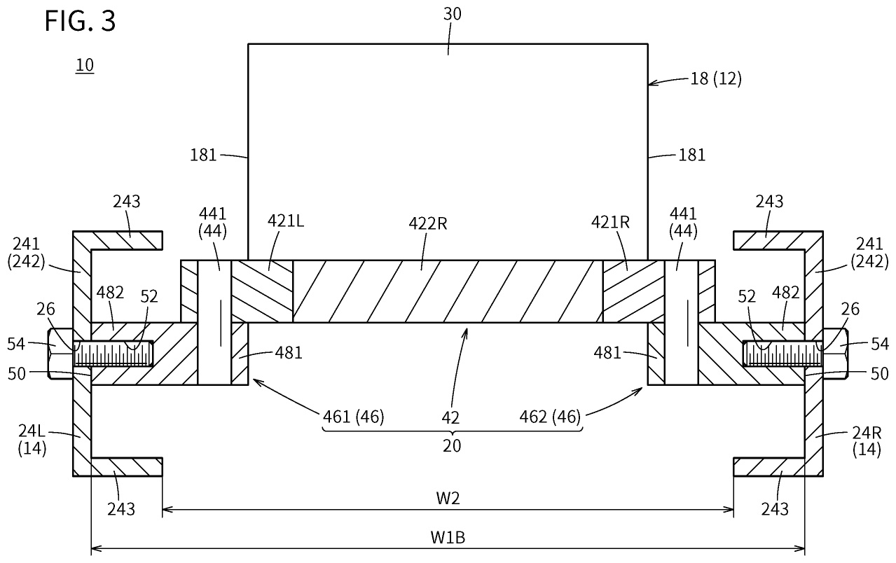

The vehicle body frame 14 is provided with a pair of side frames 24L, 24R. Each of the pair of side frames 24L, 24R extends along the front-rear direction (hereinafter, “front-rear direction”) of the fuel cell vehicle 10 (hereinafter, also referred to as vehicle 10). The pair of side frames 24L, 24R face each other in the vehicle width direction of the vehicle 10. The pair of side frames 24L, 24R are provided in parallel apart from each other in the vehicle width direction. When viewed from the front-rear direction of the vehicle 10, each of the pair of side frames 24L, 24R is formed in a U-shaped cross-section that opens inward in the vehicle width direction (see FIG. 3). It should be noted that the side frames 24L, 24R are not limited to the configuration in which each of them is formed in a U-shaped cross-section. For example, each of the side frames 24L, 24R may have a rectangular cross-section without opening in the vehicle width direction.

Each of the pair of side frames 24L, 24R is provided with a frame fastening portion 241 and a pair of projecting portions 243.

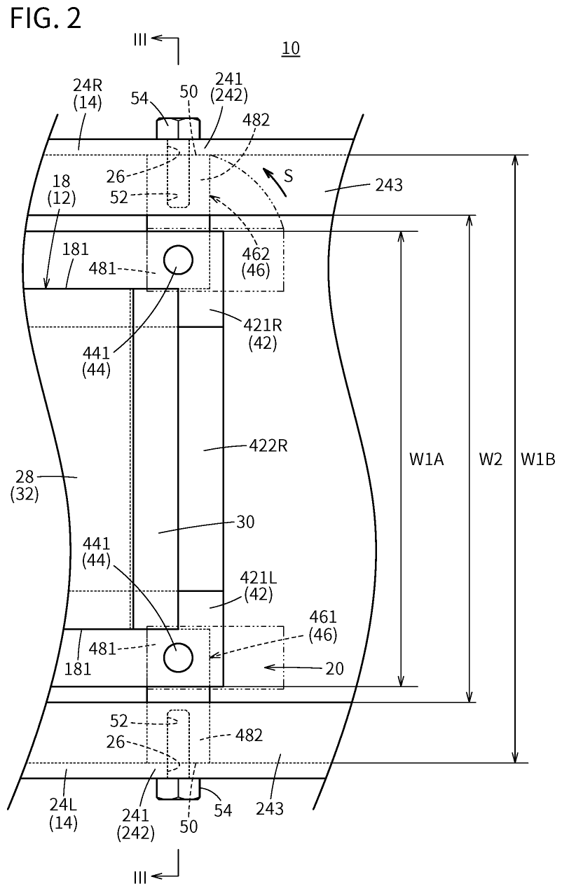

As shown in FIG. 2, the fixing structure 20 is fastened to each frame fastening portion 241. As shown in FIG. 3, the frame fastening portion 241 is provided at an outer end portion 242 in the vehicle width direction. The frame fastening portion 241 extends in the up-down direction of the vehicle 10. That is, each frame fastening portion 241 is provided at the bottom of each side frame 24L, 24R having a U-shaped cross-section. Each frame fastening portion 241 has a hole portion 26 that passes through in the vehicle width direction. The fixing structure 20 is fastened to each frame fastening portion 241. The configuration is not limited to a case where the frame fastening portion 241 is provided on the outer end portion 242 of each side frame 24L, 24R. For example, each frame fastening portion 241 may be provided at an inner end portion of the side frames 24L, 24R.

Each of the pair of projecting portions 243 projects inward in the vehicle width direction from the frame fastening portion 241. The pair of projecting portions 243 are spaced apart from each other in the up-down direction of the vehicle 10. The frame fastening portion 241 is provided between the pair of projecting portions 243.

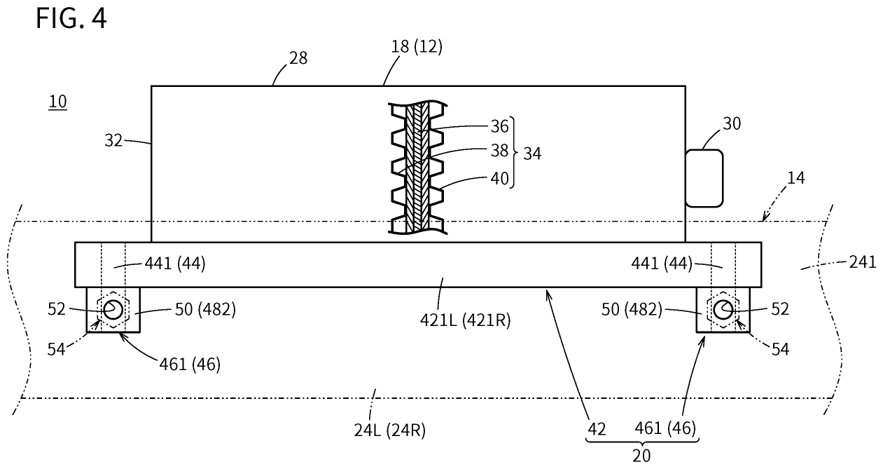

The fuel cell module 18 is fixed to the pair of side frames 24L, 24R by the fixing structure 20 (see FIG. 1). As shown in FIG. 4, the fuel cell module 18 includes a fuel cell stack 28 and a plurality of auxiliary devices 30 for driving the fuel cell stack 28. The fuel cell stack 28 has a stack case 32 and a plurality of power generating cells 34. The stack case 32 accommodates a plurality of power generating cells 34.

The plurality of power generating cells 34 generates power through an electrochemical reaction between an anode gas (fuel gas such as hydrogen) supplied from an anode system device and a cathode gas (oxygen containing gas such as air) supplied from a cathode system device. Each power generating cell 34 is composed of a membrane electrode assembly 36 and two separators 38, 40 sandwiching the membrane electrode assembly 36. The plurality of power generating cells 34 are stacked in the front-rear direction of the vehicle 10 with electrode surfaces in a standing posture. An upper surface of the fuel cell stack 28 is located at a higher position than the pair of side frames 24L, 24R.

As shown in FIG. 1, the fuel cell module 18 further includes a pair of module side portions 181. The pair of module side portions 181 are provided on both sides of the vehicle 10 in the vehicle width direction, respectively.

The fixing structure 20 fixes the fuel cell module 18 to the pair of side frames 24L, 24R.

The fixing structure 20 includes a subframe 42, a support portion 44, and a pivot member 46.

The fuel cell module 18 is fixed to the subframe 42. The subframe 42 includes a pair of side bars 421L, 421R and a pair of connecting bars 422F, 422R. The pair of side bars 421L, 421R are arranged in parallel with each other spaced apart in the vehicle width direction. The pair of connecting bars 422F, 422R are spaced apart from each other in the front-rear direction of the vehicle 10. Each of the pair of connecting bars 422F, 422R connects front end portions and rear end portions of the side bars 421L, 421R to each other. That is, the subframe 42 is formed in a rectangular shape by the pair of side bars 421L, 421R and the pair of connecting bars 422F, 422R.

As shown in FIG. 3, the support portion 44 is provided at the subframe 42. The support portion 44 supports the pivot member 46 in a pivotable manner. The support portion 44 has a shaft 441. The shaft 441 extends in the up-down direction of the subframe 42. The shaft 441 is inserted into each side bar 421L, 421R of the subframe 42 and the pivot member 46. The configuration is not limited to a case where the support portion 44 is equipped with the shaft 441. For example, the support portion 44 may be an axial portion that projects from the subframe 42 toward the pivot member 46 and is inserted into the pivot member 46.

The pivot member 46 is supported by the side bars 421L, 421R of the subframe 42 via the support portion 44. The pivot member 46 is supported by the subframe 42 in a pivotable manner. The pivot member 46 is supported by the support portion 44 provided at the subframe 42 in such a way that the pivot member 46 can pivot in the horizontal direction (see FIG. 2). The pivot member 46 is provided to be displaceable between a retracted position and a fixed position.

As shown in FIG. 3, the pivot member 46 is provided at a lower portion of the subframe 42. The pivot member 46 is fixed to a lower portion of the fuel cell module 18 via the subframe 42. The pivot member 46 is provided outward of each module side portion 181 of the fuel cell module 18 in the vehicle width direction. The configuration is not limited to a case where the pivot member 46 is provided outward of each module side portion 181 of the fuel cell module 18 in the vehicle width direction. For example, the pivot member 46 may be provided further frontward and rearward than each module side portion 181.

As shown in FIG. 1, at least two pivot members 46 are provided on both sides of each of the module side portions 181 in the vehicle width direction (see FIG. 1). A case will be described below where two pivot members 46 are provided on both sides of the pair of module side portions 181 in the vehicle width direction. The two pivot members 46 provided at one side bar 421L in plan view are also referred to as first pivot members 461 whereas the two pivot members 46 provided at the other side bar 421R are also referred to as second pivot members 462.

The two first pivot members 461 are spaced apart from each other along the extending direction of the side frame 24L. The two second pivot members 462 are spaced apart from each other along the extending direction of the side frame 24R. Each first pivot member 461 and each second pivot member 462 are arranged in parallel in the vehicle width direction of the vehicle 10. Each first pivot member 461 and each second pivot member 462 need not be arranged in parallel in the vehicle width direction of the vehicle 10.

As shown in FIG. 2, each of the first pivot member 461 and the second pivot member 462 includes a first end portion 481 and a second end portion 482. The first end portion 481 is provided at one end portion along the extending direction of each pivot member 46. The first end portion 481 is supported at the subframe 42 by the support portion 44. The first end portion 481 of the first pivot member 461 is a fixed end supported by the side bar 421L of the subframe 42. The first end portion 481 of the second pivot member 462 is a fixed end supported by the side bar 421R of the subframe 42.

The second end portion 482 is provided at an end portion of the first pivot member 461 and the second pivot member 462 opposite to the first end portion 481 in the extending direction. The second end portion 482 is a free end that is movable around the support portion 44 as a fulcrum. The second end portion 482 has a contacting portion 50. The contacting portion 50 is provided at a tip end portion of the second end portion 482. As shown in FIG. 3, the contacting portion 50 contacts and is fastened to the frame fastening portion 241.

The second end portion 482 has a fastening hole 52. The fastening hole 52 is formed along the extending direction of the pivot member 46 with opening to the contacting portion 50 of the second end portion 482. A fastening bolt 54 inserted through the hole portion 26 of the frame fastening portion 241 at the side frames 24L, 24R is fastened to the fastening hole 52. The fastening bolts 54 are fastened to the side frames 24L, 24R and the respective pivot members 46 inward in the vehicle width direction.

As shown in FIG. 2, the first pivot member 461 and the second pivot member 462 are provided to be pivotable along a horizontal plane along the extending direction of the side frames 24L and 24R via the support portion 44. At each retracted position of the first pivot member 461 and the second pivot member 462, the first end portion 481 and the second end portion 482 are arranged substantially parallel to the extending direction of the side frames 24L, 24R in plan view. At the retracted position, the first pivot member 461 and the second pivot member 462 are arranged along the front-rear direction of the vehicle 10. At the retracted position, the second end portions 482 of the first pivot member 461 and the second pivot member 462 are positioned further rearward than the first end portions 481.

As shown in FIG. 2, at each retracted position of the first pivot member 461 and the second pivot member 462, the width W1A of the fixing structure 20 in the vehicle width direction is smaller than the inter-frame distance W2, which is the width between the projecting portions 243 of the pair of side frames 24L, 24R in the vehicle width direction.

In the fixed positions of the first pivot member 461 and the second pivot member 462, the fixing structure 20 is fixed to the vehicle body frame 14. At the fixed position, at least a part of the pivot member 46 projects outward in the vehicle width direction with respect to the subframe 42. At the fixed position of the pivot member 46, the second end portion 482 is positioned further outward in the vehicle width direction than the first end portion 481. The contacting portion 50 of the second end portion 482 is fixed to the frame fastening portion 241 of each side frame 24L, 24R.

At the fixed positions of the first pivot member 461 and the second pivot member 462, the width W1B of the fixing structure 20 in the vehicle width direction is larger than the inter-frame distance W2.

Next, a case will be described where the fuel cell module 18 is assembled to the side frames 24L, 24R in the fuel cell vehicle 10.

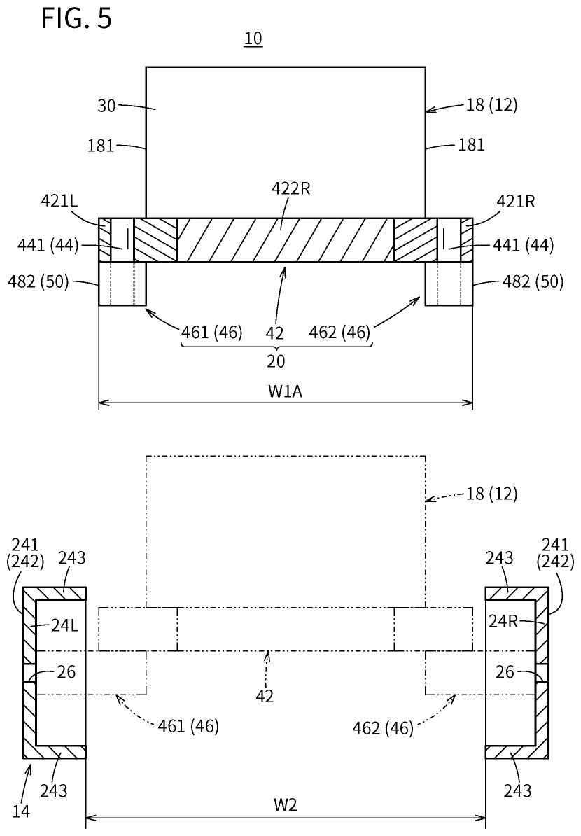

As shown in FIG. 5, the fuel cell module 18 is fixed to an upper part of the subframe 42, and the fuel cell module 18 together with the fixing structure 20 is inserted between the pair of side frames 24L, 24R (first step). This first step is performed with each of the two first pivot members 461 and the two second pivot members 462 being at the retracted position. That is, the width W1A of the fixing structure 20 in the vehicle width direction is smaller than the inter-frame distance W2, which is the width between the projecting portions 243 of the pair of side frames 24L, 24R. In this case, the width W1A of the fixing structure 20 is the maximum width between the first pivot member 461 and the second pivot member 462 in the vehicle width direction. At the retracted position, the second end portions 482 of the first pivot member 461 and the second pivot member 462 do not project outward from the side bars 421L, 421R in the vehicle width direction and are arranged to overlap the subframe 42.

Therefore, when the fixing structure 20 is inserted between the pair of side frames 24L, 24R, the first pivot member 461 and the second pivot member 462 and the projecting portions 243 of the side frames 24L, 24R do not come into contact with each other. In other words, the retracted positions of the first pivot member 461 and the second pivot member 462 are positions where contact between the pair of side frames 24L, 24R and the fixing structure 20 can be avoided.

Next, after the first pivot member 461 and the second pivot member 462 are positioned to face the frame fastening portions 241 of the pair of side frames 24L, 24R in the up-down direction of the vehicle 10 (see the double-dashed chain line shape in FIG. 5), the fixing structure 20 is fastened and fixed to each of the side frames 24L, 24R between the pair of side frames 24L, 24R (second step).

In the second step, each of the two first pivot members 461 and the two second pivot members 462 is turned with respect to the subframe 42 about the support portion 44 as a fulcrum in such a way that each second end portion 482 move outward in the vehicle width direction (direction S in FIG. 2). By turning the first pivot member 461 and the second pivot member 462, the second end portions 482 are inserted between the projecting portions 243 of the side frames 24L, 24R. At this time, the pivot angle of each of the first pivot member 461 and the second pivot member 462 is about 90°. The first pivot member 461 and the second pivot member 462 are inserted between the projecting portions 243 of the side frames 24L, 24R, respectively.

The first pivot member 461 and the second pivot member 462 are pivoted with respect to the subframe 42 to be in a fixed position. As shown in FIG. 2, at the fixed position, the second end portion 482 of the first pivot member 461 and the side frame 24L overlap with each other and the second end portion 482 of the second pivot member 462 and each projecting portion 243 of the side frame 24R overlap with each other in plan view.

As shown in FIG. 3, with the contacting portions 50 of the first pivot member 461 and the second pivot member 462 contacting the frame fastening portions 241, the fastening bolts 54 are inserted into the hole portions 26 from the outer sides in the vehicle width direction of the side frames 24L, 24R and are fastened to the fastening holes 52. Thus, the fuel cell module 18 is fixed to the side frames 24L, 24R via the first pivot member 461 and the second pivot member 462 of the fixing structure 20.

The configuration is not limited to a case where the pivot member 46 is supported by the support portion 44 extending along the up-down direction to be pivotable in the horizontal direction. For example, the pivot member 46 may be supported by a support portion extending along the extending direction of the side frames 24L, 24R to be pivotable in the vertical direction. In this case, at the retracted position of the pivot member 46, the pivot member 46 is retracted to a position where the pivot member 46 overlaps the subframe 42 in plan view, and at the fixed position, the pivot member 46 is pivoted outward in the vehicle width direction with the support portion as a fulcrum to project the second end portion 482 outward in the vehicle width direction.

The present embodiment provides the following benefits.

As shown in FIG. 2, the fixing structure 20 of the fuel cell vehicle 10 is provided with the pivot member 46 that is supported by the subframe 42 in a pivotable manner. The pivot member 46 is provided to be displaceable between the retracted position and the fixed position projecting outward in the vehicle width direction with respect to the subframe 42. At the retracted position, the width W1A of the fixing structure 20 is smaller than the inter-frame distance W2 of the pair of side frames 24L, 24R, and at the fixed position, the width W1B of the fixing structure 20 is larger than the inter-frame distance W2. The fixing structure 20 with the pivot member 46 being in the fixed position is fixed to the vehicle body frame 14.

According to this configuration, the ease of assembly of the fuel cell module 18 with respect to the pair of side frames 24L, 24R can be improved.

As shown in FIG. 3, when viewed from the front-rear direction of the vehicle 10, each of the pair of side frames 24L, 24R is formed in a U-shaped cross-section that opens inward in the vehicle width direction. The pivot member 46 of the fixing structure 20 is fastened to the frame fastening portion 241 provided at the outer end portion 242.

According to this configuration, it is possible to fix the fuel cell module 18 more effectively by providing the frame fastening portion 241 at the outer end portion 242 of the side frames 24L, 24R having high rigidity.

As shown in FIG. 2, the pivot member 46 includes the first end portion 481 supported by the subframe 42 and the second end portion 482 having the contacting portion 50 contacting the frame fastening portion 241. In the fixed position, the second end portion 482 is positioned further outward in the vehicle width direction than the first end portion 481, and the second end portion 482 is fixed to the frame fastening portion 241.

According to this configuration, the pivot member 46 can be effectively pivoted about the first end portion 481 as a fulcrum, and the pivot member 46 can be effectively fixed to the side frames 24L, 24R by the second end portion 482.

The fuel cell module 18 has module side portions 181 provided on both sides in the vehicle width direction, and the pivot members 46 (the first pivot member 461, the second pivot member 462) are provided on the outer side of each of the module side portions 181 in the vehicle width direction.

According to this configuration, the fuel cell module 18 can be more effectively fixed to the side frames 24L, 24R by the pivot members 46 provided on both sides in the vehicle width direction.

As shown in FIG. 1, two or more of the pivot members 46 (first pivot member 461, second pivot member 462) are provided on the outer side of each of the module side portions 181 in the vehicle width direction.

According to this configuration, the fuel cell module 18 can be effectively fixed to the side frames 24L, 24R by the plurality of pivot members 46.

As shown in FIG. 3, the pivot member 46 is fixed to a lower portion of the fuel cell module 18 via the subframe 42. According to this configuration, the fuel cell module 18 can be effectively fixed to the pair of side frames 24L, 24R.

As shown in FIG. 2, the fixing structure 20 has the support portion 44 provided at the subframe 42 to support the pivot member 46 in a pivotable manner. The support portion 44 supports the pivot member 46 to be pivotable in the horizontal direction.

According to this configuration, the pivot member 46 can be effectively pivoted in a horizontal plane extending along the extending direction of the side frames 24L, 24R.

As shown in FIG. 5, the method for manufacturing the fuel cell vehicle 10 includes a first step of inserting the fixing structure 20 between the pair of side frames 24L, 24R with the pivot member 46 being in the retracted position, and a second step of pivoting the pivot member 46 between the pair of side frames 24L, 24R with respect to the subframe 42 to be in the fixed position and fastening the pivot member 46 in the fixed position and the side frames 24L, 24R to each other.

According to this manufacturing method, after the fuel cell module 18 is placed between the pair of side frames 24L, 24R, the pivot member 46 is pivoted to project further outward than the projecting portions 243 of the side frames 24L, 24R in the vehicle width direction. Thus, the ease of assembly of the fuel cell module 18 with respect to the pair of side frames 24L, 24R can be improved.

With respect to the above disclosure, the following supplementary notes are further disclosed.

### Supplementary Note 1

A fuel cell vehicle (10) includes a vehicle body frame (14) including a pair of side frames (24L, 24R) facing each other in the vehicle width direction, a fuel cell module (18), and a fixing structure (20) configured to fix the fuel cell module to the pair of side frames, wherein each of the pair of side frames includes a frame fastening portion (241) to which the fixing structure is fastened, and a projecting portion (243) projecting inward in the vehicle width direction from the frame fastening portion, the fixing structure includes a subframe (42) to which the fuel cell module is fixed, and a pivot member (46) supported in a pivotable manner on the subframe and displaceable between a retracted position and a fixed position projecting outward in the vehicle width direction with respect to the subframe, at the retracted position of the pivot member, the width (W1A) of the fixing structure in the vehicle width direction is smaller than the inter-frame distance (W2) that is the width between the projecting portions of the pair of side frames in the vehicle width direction, and at the fixed position of the pivot member, the width (W1B) of the fixing structure in the vehicle width direction is larger than the inter-frame distance, and the fixing structure with the pivot member at the fixed position is fixed to the vehicle body frame.

According to the fuel cell vehicle, the ease of assembly of the fuel cell module to the pair of side frames can be improved.

### Supplementary Note 2

In the fuel cell vehicle described in Supplementary note 1, when viewed from the vehicle front-rear direction, each of the pair of side frames may be formed in a U-shaped cross-section that opens inward in the vehicle width direction, the frame fastening portion may be provided at an outer end portion (242) in the vehicle width direction, and the pivot member may be fastened to the outer end portion. According to this configuration, it is possible to fix the fuel cell module more effectively by providing the frame fastening portion at the outer end portion of the side frames having high rigidity.

### Supplementary Note 3

In the fuel cell vehicle described in Supplementary note 1 or 2, the pivot member may include a first end portion (481) supported by the subframe, and a second end portion (482) provided on the opposite side with respect to the first end portion in the extending direction of the pivot member and including a contacting portion (50) contacting the frame fastening portion, and at the fixing position, the second end portion may be placed further outward in the vehicle width direction than the first end portion, and the second end portion may be fixed to the frame fastening portion. According to this configuration, the pivot member can be effectively pivoted about the first end portion as a fulcrum, and the pivot member can be effectively fixed to the side frames by the second end portion.

### Supplementary Note 4

In the fuel cell vehicle according to Supplementary note 1 or 2, the fuel cell module may include module side portions (181) provided on both sides in the vehicle width direction, and the pivot member may be provided outward of each of the module side portions in the vehicle width direction. According to this configuration, the fuel cell module can be more effectively fixed to the side frames by the pivot members provided on both sides in the vehicle width direction.

### Supplementary Note 5

In the fuel cell vehicle described in Supplementary note 4, a plurality of the pivot members may be provided outward of each of the module side portions in the vehicle width direction. According to this configuration, the fuel cell module can be effectively fixed to the side frames by a plurality of pivotal members.

### Supplementary Note 6

In the fuel cell vehicle according to Supplementary note 1 or 2, the pivot member may be fixed to a lower portion of the fuel cell module via the subframe. According to this configuration, the fuel cell module can be effectively fixed to the pair of side frames.

### Supplementary Note 7

In the fuel cell vehicle according to Supplementary note 1 or 2, the fixing structure may include a support portion (44) provided on the subframe and configured to support the pivot member in a pivotable manner, and the support portion may support the pivot member to be pivotable in a horizontal direction. According to this configuration, the pivot member can be effectively pivoted in a horizontal plane extending along the extending direction of the side frames.

### Supplementary Note 8

A fuel cell vehicle includes a vehicle body frame including a pair of side frames facing each other in the vehicle width direction, a fuel cell module, and a fixing structure configured to fix the fuel cell module to the pair of side frames, wherein the fuel cell module is fixed to the pair of side frames by the fixing structure, each of the pair of side frames includes a frame fastening portion to which the fixing structure is fastened, and a projecting portion projecting inward in the vehicle width direction from the frame fastening portion, the fixing structure includes a subframe to which the fuel cell module is fixed, and a pivot member supported in a pivotable manner by the subframe and displaceable between a retracted position and a fixed position projecting outward in the vehicle width direction with respect to the subframe, at the retracted position of the pivot member, the width of the fixing structure in the vehicle width direction is smaller than an inter-frame distance that is the width between the projecting portions of the pair of side frames in the vehicle width direction, and at the fixed position of the pivot member, the width of the fixing structure in the vehicle width direction is larger than the inter-frame distance, and a method for manufacturing the fuel cell vehicle includes a first step of inserting the fixing structure between the pair of side frames with the pivot member being at the retracted position, and a second step of pivoting the pivot member between the pair of side frames with respect to the subframe to be at the fixed position and fastening the pivot member at the fixed position and the pair of side frames with each other.

According to this method for manufacturing a fuel cell vehicle, after the fuel cell module is placed between the pair of side frames, the pivot members are pivoted to project further outward than the projecting portions of the side frames in the vehicle width direction, thereby improving the ease of assembly of the fuel cell module to the pair of side frames.

Although the present disclosure has been detailed, the present disclosure is not limited to the individual embodiments described above. These embodiments may be variously added, replaced, altered, partially deleted, etc., without departing from the scope of the present disclosure or the intent of the present disclosure as derived from the claims and their equivalents. These embodiments can also be implemented in combination. For example, in the above-described embodiment, the order of the operations and the order of the processes are shown as an example, and are not limited to these. The same applies to the case where numerical values or mathematical expressions are used in the description of the above-described embodiment.

1. A fuel cell vehicle comprising: a vehicle body frame including a pair of side frames facing each other in a vehicle width direction; a fuel cell module; and a fixing structure configured to fix the fuel cell module to the pair of side frames, wherein
each of the pair of the side frames includes
a frame fastening portion to which the fixing structure is fastened; and
a projecting portion projecting inward in the vehicle width direction from the frame fastening portion,
the fixing structure includes
a subframe to which the fuel cell module is fixed; and
a pivot member supported in a pivotable manner on the subframe and displaceable between a retracted position and a fixed position projecting outward in the vehicle width direction with respect to the subframe,
at the retracted position of the pivot member, a width of the fixing structure in the vehicle width direction is smaller than an inter-frame distance that is a width between the projecting portions of the pair of side frames in the vehicle width direction, and
at the fixed position of the pivot member, the width of the fixing structure in the vehicle width direction is larger than the inter-frame distance, and the fixing structure with the pivot member being at the fixed position is fixed to the vehicle body frame.

2. The fuel cell vehicle according to claim 1, wherein
when viewed from a vehicle front-rear direction, each of the pair of side frames is formed in a U-shaped cross-section that opens inward in the vehicle width direction, and
the frame fastening portion is provided at an outer end portion in the vehicle width direction, and the pivot member is fastened to the outer end portion.

3. The fuel cell vehicle according to claim 1, wherein
the pivot member includes
a first end portion supported by the subframe, and
a second end portion provided on an opposite side from the first end portion in an extending direction of the pivot member and including a contacting portion contacting the frame fastening portion, and
at the fixed position, the second end portion is placed further outward in the vehicle width direction than the first end portion, and the second end portion is fixed to the frame fastening portion.

4. The fuel cell vehicle according to claim 1, wherein
the fuel cell module includes module side portions provided on both sides in the vehicle width direction, and
the pivot member is provided outward of each of the module side portions in the vehicle width direction.

5. The fuel cell vehicle of claim 4, wherein
a plurality of the pivot membersare provided outward of each of the module side portions in the vehicle width direction.

6. The fuel cell vehicle according to claim 1, wherein
the pivot member is fixed to a lower portion of the fuel cell module via the subframe.

7. The fuel cell vehicle according to claim 1, wherein
the fixing structure includes a support portion provided on the subframe and configured to support the pivot member in a pivotable manner, and
the support portion supports the pivot member to be pivotable in a horizontal direction.

8. A method of manufacturing a fuel cell vehicle including:
a vehicle body frame including a pair of side frames facing each other in a vehicle width direction; a fuel cell module; and a fixing structure configured to fix the fuel cell module to the pair of side frames,
each of the pair of the side frames includes
a frame fastening portion to which the fixing structure is fastened; and
a projecting portion projecting inward in the vehicle width direction from the frame fastening portion,
wherein
the fixing structure includes
a subframe to which the fuel cell module is fixed; and
a pivot member supported in a pivotable manner on the subframe and displaceable between a retracted position and a fixed position projecting outward in the vehicle width direction with respect to the subframe,
wherein
at the retracted position of the pivot member, a width of the fixing structure in the vehicle width direction is smaller than an inter-frame distance that is a width between the projecting portions of the pair of side frames in the vehicle width direction, and
at the fixed position of the pivot member, the width of the fixing structure in the vehicle width direction is larger than the inter-frame distance,
the method comprising:
a first step of inserting the fixing structure between the pair of side frames with the pivot member being at the retracted position; and
a second step of pivoting the pivot member between the pair of side frames with respect to the subframe to be at the fixed position and fastening the pivot member being at the fixed position and the pair of side frames with each other.
